(19) United States
(12) Patent Application Publication
(10) Pub. No.: US 2007/0288724 A1
(43) Pub. Date: Dec. 13, 2007

(54) Microprocessor

(76) Inventors: Hiroki Goko, Tokyo (JP); Kenichi Morioka, Tokyo (JP)

Correspondence Address: NIXON PEABODY, LLP, 401 9TH STREET, NW, SUITE 900, WASHINGTON, DC, 20004-2128, US

(21) Appl. No.: 11/730,001

(22) Filed: Mar. 29, 2007

(30) Foreign Application Priority Data
May 8, 2006 (JP) 2006-129046

(51) Int. Cl. G06F 9/30; G06F 15/00; G06F 9/40

(52) U.S. Cl. 712/219; 712/E09.001

(57) ABSTRACT

Halting clocks of pipeline registers 28-31 and data memory 26, etc., and holding input data of each of FE, DC, MEM, WB stages, during when a nop is sent to each of pipelines, by a first process for outputting a nop signal S41 of logic level “H” when the nop is detected by a nop detecting circuit 41, a second process for sending the detected nop signal to each of the pipelines by F/Fs 46-48 placed between each of the pipelines, and a third process for halting clocks by clock control circuits 42-45 placed in each of the pipelines when the nop signal is sent to each of the pipelines.

### BACKGROUND OF THE INVENTION

1. Field of the Invention

The present invention relates to a RISC-type microprocessor (hereinafter referred to as “MPU”) adopting the pipeline configuration, one of speeding-up techniques, and especially relates to a technique for reducing the power consumption of the MPU thereof.

2. Description of the Related Art

A MPU is a semiconductor chip for basic computing within the computer. The computing of the MPU thereof has a computing flow as follows. First, the MPU reads programs stored in memories (memory devices), secondly, receives data from input devices or memories, etc., according to instructions of the programs and computes the data corresponding to the programs, then the MPU sends the data thereof to memories or displays (showing devices).

Basic architecture of the above MPU is mainly divided to two types, the CISC architecture and the RISC architecture. The CICS architecture improves the computing throughput by increasing instructions to close the instruction set to a high-level language so that complicated instruction can be done. Meanwhile, the RISC architecture improves the computing throughput by simplifying each of the instructions so that a plural of instructions can be done efficiently and simultaneously. However, both architectures are developing by adopting the other advantages each other, and then the border of the both architectures is becoming unclear.

Furthermore, one of the speeding-up techniques is the pipeline computing. The computing of one instruction within the MPU is configured by a cycle having plural of steps (process (stage)), such as reading instruction, interpretation, executing, writing of results, etc., and usually, the next instruction computing can not be started before the previous instruction cycle has not be completed. Therefore, in order to speed up the above computing, the pipeline computing is necessary for operating each stage computing independently so as to start the next instruction computing with assembly-line precision before the previous instruction computing is complete. The MPU having the above pipeline architecture (configuration) can operate an interpretation of the next instruction during operation of the previous instruction.

FIG. 2 is a view of general configuration diagram showing a pipeline configuration example of a MPU having the conventional RISC architecture.

The general configuration diagram thereof shows a five-stage pipeline having five stages of fetch (hereinafter referred to as “FE”)/decode (hereinafter referred to as “DC”)/execution (hereinafter referred to as“EX”)/memory (hereinafter referred to as “MEM”)/write back (hereinafter referred to as “WB”).

The MPU includes a address generating register 1, an instruction memory 2, an instruction decoder 3, a register set 4, an arithmetic and logic unit (ALU) 5, and a data memory 6.

Furthermore, a program counter (hereinafter referred to as “PC”) 7 is included between the address generating register 1 and the instruction memory 2;

a pipeline register between FE/DC stages (hereinafter referred to as “FE/DC pipeline register”) 8 is included between the instruction memory 2 and the instruction decoder 3;

a pipeline register between: DC/EX stages (hereinafter refereed to as “DC/EX pipeline register”) 9 is included between the instruction decoder 3, the register set 4, and arithmetic and logic unit (ALU) 5;

a pipeline register between EX/MEM stages (hereinafter referred to as “EX/MEM pipeline register”) 10 is included between the arithmetic and logic unit (ALU) 5 and the data memory 6; and

a pipeline register between MEM/WB stages (hereinafter referred to as “MEM/WB pipeline register”) 11 is included between the data memory 6 and the register set 4; respectively.

The PC 7, the instruction memory 2, and each of the pipeline registers 8-11 operate, synchronized with the clock CK.

In the pipeline computing of the above MPU, the following stages (1)-(5) are done sequentially.

(1) FE Stage

An instruction (program data) is fetched from the memory 2.

(2) DC Stage

The instruction decoder 3 decodes the fetched instruction. At the same time, a register operand is read (fetched) from the register set 4.

(3) EX Stage

The arithmetic and logic unit 5 computes, based on the above decoding results, or bypasses the value of the register set 4. In other words, in the EX stage thereof, the arithmetic and logic unit 5 computes (executes the instruction), based on the above decoding results and the fetched value of register set 4. For example, in the case of a load/store instruction, an effective address is computed. In the case of a branch instruction, a branch address is computed.

(4) MEM Stage

A Read (read out)/write (write in) operation to the data memory 6 is done (that is, read the value of the data memory 6 corresponding to the address calculated in the EX stage, or write the data to the data memory 6), or a bypass operation of the computing results to the register set 4 is done.

(5) WB Stage

The calculating results in the EX stage or the operand fetched in the MEM, stage is stored in the register set 4 (that is write back to the register set 4).

Between the above stages from (1) to (5), the FE/DC pipeline register 8, the DC/EX pipeline register 9, the EX/MEM pipeline 10, and the MEM/WB pipeline register 11 are included, and transfer data between each of the registers.

However, in the above pipeline configuration, during non-operation (hereinafter referred to as “nop”) period when no operation is done, the instruction code assigned to the nop instruction is fetched from the instruction memory 2, too, and subsequently the pipeline operation of the nop instruction is done. That is, there is a problem that unnecessary power consumption is consumed because the pipeline registers from 8 to 11, the registers set 4, and the arithmetic and logic unit 5 operate even during the nop-operation period when no operation is done.

As the conventional MPU technology to solve the above problem, there is the technology described in the following document.
Patent Document: Japanese Patent Laid-Open Number H08-101820

According to the MPU technology described in the above patent document 1, when no operation is done in the data path unit, the input data is fetched by the latch circuit placed in the input stage of the data path unit so that operations of circuits inside the data path can be halted.

### SUMMARY OF THE INVENTION

### Problem To Be Solved

However, according to the conventional MPU technology described in the patent document 1, since latch circuits, etc., needs to be included in the input stage of the data path unit in order to realize halting operations inside circuits of the data path, the circuit volume becomes large, and additionally there are lots of circuits still remained to operate, such as the pipeline registers from 8 to 11, etc., in the whole circuit. Therefore, there is a problem that the effect of reducing power consumption is low, and it is not easy to solve the above problem.

### Solution To Solve The Problem

A MPU according to the claim 1 of the invention includes' a nop-detecting circuit, a plural of flip-flops (hereinafter, referred to as “F/F”), and a plural of clock control circuits.

The nop-detecting circuit detects a nop among fetched instruction data from the instruction memory so as to output a nop signal.

The plural of F/Fs are placed between each of the plural of pipelines and send the above nop signal to each of the above plural of pipelines.

The plural of clock control circuits are placed in each of the above pipelines, halts clocks for operating stages of each of the above pipeline, based on the above nop signal in the above each stage of the above pipelines when the above nop is sent to each of the above pipelines, and at the same time, holds the input data in the above stages.

A MPU according to the claim 2 of the invention includes a instruction memory, a plural of F/Fs, and a plural of clock control circuits.

The instruction memory stores the instruction data including a nop-only bit indicating whether the instruction is nop, or not.

The plural of F/Fs are placed between each of the plural of pipelines and send the above nop signal to each of the above plural of pipelines in the case where the above nop-only bits of the above instruction data read out from the above instruction memory indicates the nop.

The plural of clock control circuits are placed in each of the above pipelines, halt clocks for operating stages of each of the above pipeline, based on the above nop signal in the above each stage the above pipelines when the above nop are sent to each of the above pipelines, and at the same time, hold the input data in the above stages.

A MPU according to the claim 3 of the invention includes a first instruction memory, a second instruction memory, a first clock control circuit, a first F/F, a plural of second F/Fs, and a plural of second clock control circuits.

The first instruction memory stores the instruction data except nop-only bits when the instruction is the nop, and operates at leading edge of the clock.

The second instruction memory stores only the nop-only bits, and operates at trailing edge of the clock.

The first clock control circuit halts the clock of the first instruction memory when the above nop-only bit are read out from the second instruction memory.

The first F/Fs is placed in the F/E stage of the first-stage pipeline of the plural of pipelines adjusting the timing of the above nop-only bit read out from the second instruction memory and outputs the nop signal thereof.

The second plural of F/Fs are placed between each of the plural of pipelines and send the nop signal to each of the above pipelines a half cycle ahead the above clock.

The plural of second clock control circuits are placed in each of the above pipelines, halt clocks for operating stages of each of the above pipeline, based on the above nop signal in the above stage of each of the above pipelines when the above nop is sent to each of the above pipelines, and at the same time, hold the input data in the above stages of each of the above pipelines.

A MPU according to the claim 4 of the invention includes a control-signal generating circuit, a plural of F/Fs, a plural of nop signal generating circuits, and a plural of clock control circuits.

The control-signal generating circuit is placed in the DC stage of the plural of pipelines, and generates a plural of clock-enable signals, based on the decoding results of the instruction decoder.

The plural of F/Fs are placed between each of the pipelines in the above EX stage and above MEM stage after the above DC stage, and send the above plural of clock-enable signals to the above EX stage and the MEM stage.

The plural of clock control circuits are placed in the above EX stage and the MEM stage and halt clocks for operating the above EX stage and the MEM stage, based on the above nop signal when the above decoding result indicates that the computing by the instruction will be completed in the middle of the above pipeline stages.

A MPU according to the claim 5 of the invention includes a control-signal generating circuit, a plural of F/Fs, and a plural of clock control circuits.

The control-signal generating circuit is placed in the DC stage of the plural of pipelines, and generates a plural of clock-halt signals, based on the decoding results of the instruction decoder.

The plural of F/Fs are placed between each of the pipelines after the above DC stage, and send the above plural of clock-halt signals.

The plural of clock control circuits are placed in the above pipelines of the stages after the above DC stage and halt clocks for operating partially the above pipelines of the stages after the above DC stage, based on the above clock-halt signals.

The MPU according to the claim 1 includes;

a nop detecting circuit configured to detect the nop signal, for example, of one bit, from the instruction data fetched from the the instruction memory and outputs;

a F/Fs placed between each of the pipelines in order to send the nop signal to each of the pipelines; and

a clock control circuit configured to halt the clocks in each stage of the pipelines based on the nop signal.

When the nop signal is detected by the nop detecting circuit, the clocks of the pipelines and the memories, etc. are halted and the input data of each stage of the pipelines are held during sending the nop signal to each pipeline, by the first operation for outputting the nop signal having, for example, logic level “H”, the second operation for sending the detected nop signal to each pipeline, and the third operation for halting the clocks by the clock control circuits placed in each pipeline. Consequently, the reduction of the power consumption can be done.

The MPU according to the claim 2 includes the instruction memory having the nop-only bit of one bit indicating whether the instruction is the nop, or not, and is configured to assign the nop-only bit of the instruction data fetched from the above instruction memory to the nop signal and thereinafter conduct the same clock-control operation as in the claim 1. Consequently, the power consumed in the nop detecting circuit for detecting the nop operation from the instruction data fetched from the above instruction memory can be further reduced, and at the same time, delay time in the nop detecting circuit can be eliminated, therefore further speeding-up of the operation can be done.

A MPU according to the claim 3 of the invention includes a first instruction memory, a second instruction memory, F/Fs, a clock control circuit, and a F/F.

The first instruction memory stores an instruction data except the nop-only bit indicating, for example, logic level “H” in the case where the instruction is the nop, and operates, for example, at the rising edge of clocks.

The second instruction memory stores only the nop-only bit and operates, for example, at the falling edge of clocks.

The clock control circuit halts the clock of the first instruction memory in the case where the signal read from the above second instruction memory has, for example, logic level “H”.

The F/F placed in the FE stage so as to adjust the timing of the nop-only bit read from the above second instruction memory.

Furthermore, the above MPU according to the claim 3 is configured to conduct;

a first operation for reading the nop-only bit, for example, at the falling edge of the clock from the second instruction memory;

a second operation for halting the clock of the first instruction memory in the case where the above read data has, for example, logic level “H”;

a third operation for adjusting the above read data by the F/F placed on the FE stage so as to use the adjusted data thereof as the nop signal; and

an operation after the third operation for conducting the same control of the clock as in the claim 2.

Consequently, adding to the effect described in the claim 2, the power consumption of the instruction memories can be reduced by reading the nop-only bit a half-clock-cycle prior to reading other instruction data and by halting to fetch other instruction data in the case of the nop.

The MPU according to the claim 4 includes;

a control signal generating circuit placed in the DC stage in order to generate a plural of clock enable signals;

F/Fs placed between each of the pipelines in order to send the clock enable signals generated in the DC stage to the EX and MEM stages; and

nop signals generating circuit placed in each of the pipeline stages in order to generate the nop signal based on the clock enable signal generated in the control signal generating circuit.

Consequently, by conducting the same operation as the in the nop operation after the operation completed in the middle of the pipeline stage, during the wider parts of operations added to the nop operation, reduction of the power consumption can be done.

The MPU according to the claim 5 includes;

a control signal generating circuit placed in the DC stage; and

a plural of F/Fs placed between each of the pipelines after the DC stage in order to send a plural of clock halt control signals from the above control signal generating circuit.

For example, in the case where the control signal of logic level “H” having more than one bit is sent to the F/Fs and the load/store operation is done, the clock to the pipeline register is halted so as not to change the input to the ALU in the EX stage, and only the clocks to the write back register set are halted in the MEM stage. As the above-mentioned example, by partially controlling each of the pipeline registers, the power reduction is applicable to more cases.

### BRIEF DESCRIPTION OF THE DRAWINGS

FIG. 1: A view of general configuration diagram showing a pipeline configuration example of RISC-type MPU according to the first embodiment.

FIG. 2: A view of general configuration diagram showing a pipeline configuration example of the conventional RISC-type. MPU.

FIG. 3: A view of circuit diagram showing an example of the nop detecting circuit 41 of FIG. 1.

FIG. 4: A view of circuit diagram showing an example of the clock control circuit 42 of FIG. 1.

FIG. 5: A view of timing chart showing a specific operation example of the MPU of FIG. 1.

FIG. 6: A view of general configuration diagram showing a pipeline configuration example of RISC-type MPU according to the second embodiment.

FIG. 7: A view of general configuration diagram showing a pipeline configuration example of RISC-type MPU according to the third embodiment.

FIG. 8: A view of timing chart showing an operation of the MPU of FIG. 7.

FIG. 9: A view of general configuration diagram showing a pipeline configuration example of RISC-type MPU according to the forth embodiment.

FIG. 10: A view of circuit diagram showing a configuration example of the control signal generating circuit 61 of FIG. 9.

FIG. 11: A view of general configuration diagram showing a pipeline configuration example of RISC-type MPU according to the fifth embodiment.

### DETAILED DESCRIPTION OF THE PREFERRED EMBODIMENTS

The MPU according to the present invention includes the nop detecting circuit for detecting the nop from the fetched instruction data from the instruction memory, the F/Fs placed between each of the pipelines in order to send the nop signal to each of the pipelines, and the clock control circuits for halting the clock at each of the pipeline stages based on the nop signal.

In the MPU according to the present invention, the clocks of the pipeline registers and the memories, etc. are halted and simultaneously the input data of each of pipeline stages are held during sending the nop to each of the pipelines, by the first process for outputting the nop signal, of logic level “H” when the nop is detected by the nop detecting circuit, the second process for sending the above detected nop signal to each of the pipelines, and the third, process for halting the clocks by the clock control circuits placed in each of the pipelines.

### First Embodiment

### Configuration of the First Embodiment

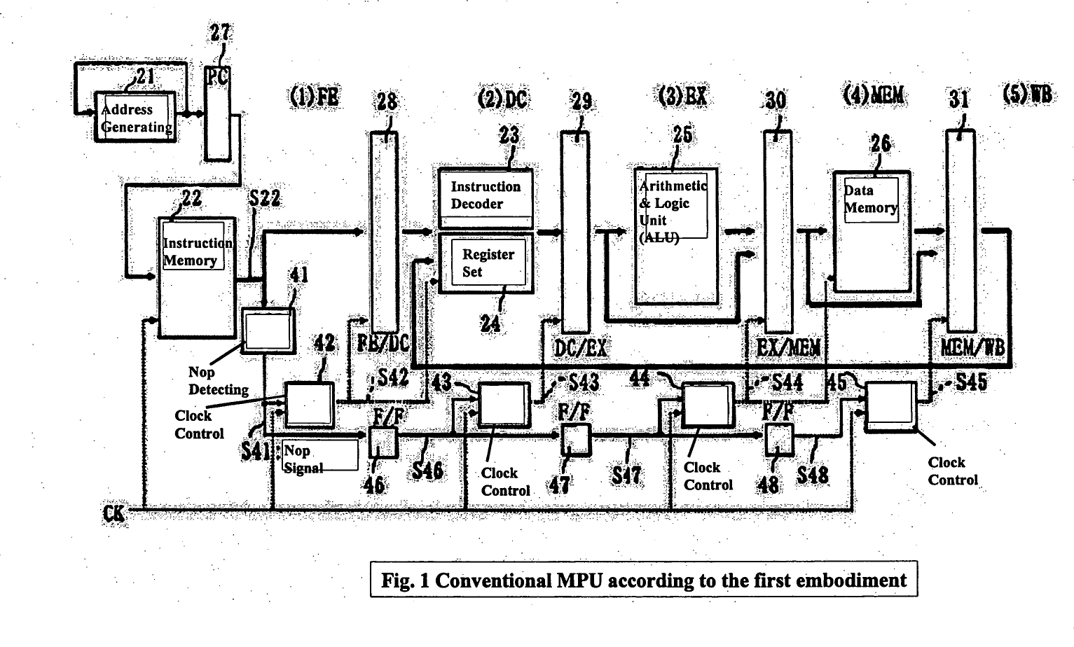

FIG. 1 is a view of general configuration diagram showing a configuration example of pipeline of a RISC-type MPU according to the first embodiment of the invention.

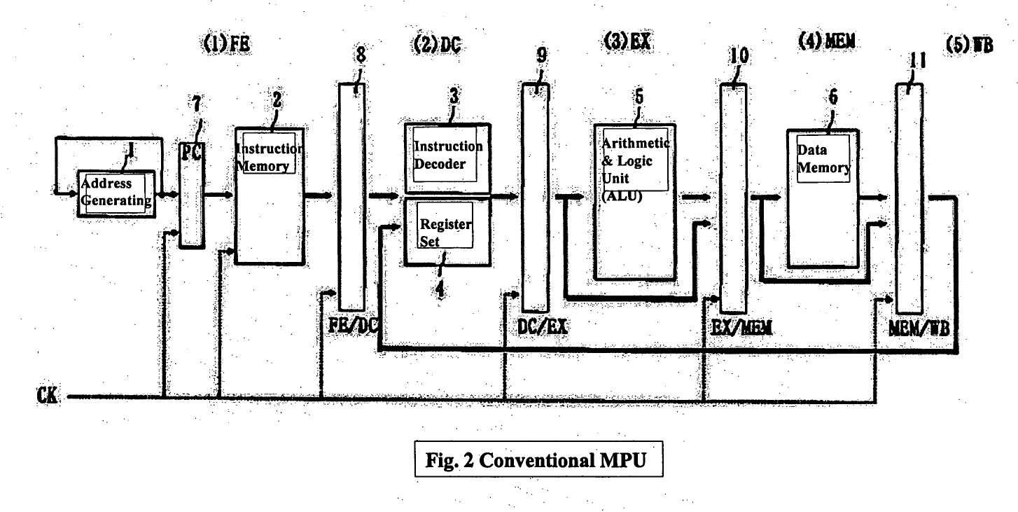

The above general configuration diagram shows an example of five-stage pipeline having the five stages of FE/DC/EX/MEM/WB as in the conventional case of FIG. 2.

As in the conventional case of FIG. 2, the MPU according to the first embodiment includes a address generating register 21, an instruction memory 22, an instruction decoder 23, a register set 24, an arithmetic and logic unit (ALU) 25, and a data memory 26, and the MPU according to the first embodiment further includes a PC 27 between the address generating register 21 and the instruction memory 22, a FE/DC pipeline register 28 between the instruction memory 22 and the instruction decoder 23, a DC/EX pipeline register 29 between the instruction decoder 23 and the ALU 25 and between the register set 24 and the ALU 25, an EX/MEM pipeline register 30 between the ALU 25 and the data memory 26, and a MEM/WB pipeline register 31 between the data memory 26,and the register set 24, respectively.

The first embodiment is characterized by including additionally to the conventional MPU configuration;

a nop detecting circuit 41 for detecting the nop instruction from a fetched data (instruction data) S22 from the instruction memory 22;

clock control circuits 42-45 placed in each of the pipeline stages; and

F/Fs 46-48 placed between each of the pipeline stages so as to send one-bit nop signal S41 from the nop detecting circuit 41 indicting that the instruction is the nop instruction.

Each of the F/Fs 46-48 outputs one-bit nop signals S46-S48. The instruction memory 22 and clock control circuits 42-45 operate synchronized with the clock CK. Each of clock control circuits 42-45 is provided with each of one-bit nop signals S41, S46-47 as enable signals (activating signal) 7, and generates gated clocks S42-S45 based on the clock CK. Each of the pipeline register 28-31 is configured to operate synchronized with each of the gated clock S42-S45, the register set 24 is configured to operate based on the gated clock S42, and the data memory 26 is configured to operate based on gated clock S44. The above configurations is a characteristic of the first embodiment and a different point from the conventional MPU.

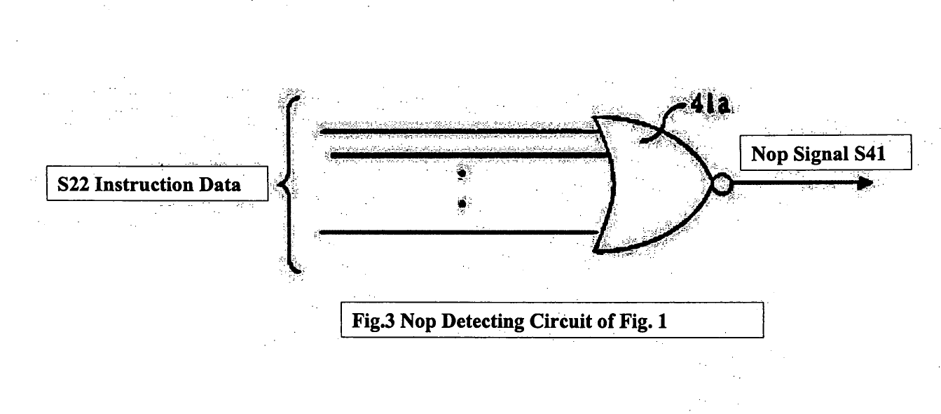

FIG. 3 is a view of circuit diagram showing a configuration example of the nop detecting circuit 41 of FIG. 1. The above nop detecting circuit 41 detects the nop instruction from the decoding results of the instruction decoder S22 and outputs a logic level “H” of the nop signal S41. It depends on the instruction code of the nop instruction, however, for example, in the case where all bits of the nop instruction code are zero, the nop detecting circuit 41 comprises a nondisjunction gate (hereinafter referred as “NOR gate”) 41a.

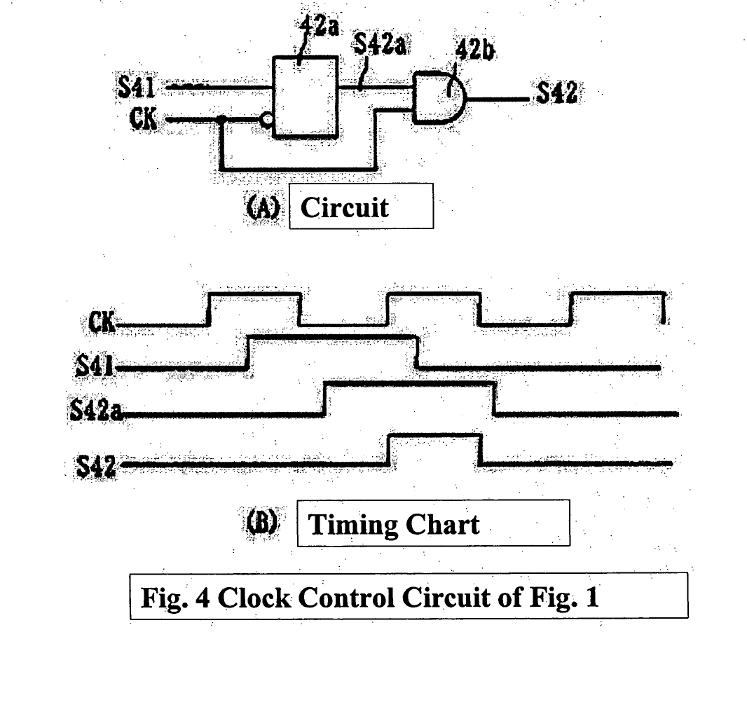

FIG. 4(A), (B) are views of diagrams showing configuration examples of the clock control circuit 42 of FIG. 1. FIG. 4(A) is a view of circuit diagram, and FIG. 4(B) is a view of timing chart of the input and the output of the circuit thereof.

Each of the clock control circuits 42-45 of FIG. 1 has the same circuit configuration to each other. As shown in FIG. 4(A), the clock control circuit 42 comprises; a D-type latch circuit 42a for reading in the nop signal S41 as the enable signal based on, for example, the inverted signal of the clock CK; and a logical multiplication gate (hereinafter referred to as “AND gate”) 42b for logical multiplication of an output signal S42a from the above D-type latch circuit 42a and the clock CK and for outputting the operating result as the gated clock S42. The above clock control circuit 42 has a function of gating the clock CK by the AND gate 42b and outputting the gated clock S42 from the. AND gate 42b corresponding to the nop signal S41 provided the D-type latch circuit 42a in order to carry no hazard signals with the gated clock S42 at whatever timing the nop signal S41 of the enable signal is inputted.

As shown in FIG. 4(B), the D-type latch circuit 42a read in the logic level “H” of the nop signal S41 at the falling edge of the clock CK and output the output signal S42a to the AND gate 42b. When the output signal 42a has logic level “H”, the AND gate 42b opens the gate and passes the clock CK to output the gated clock S42.

The above gated clock S42 is inputted to the clock input terminal of the FE/DC pipeline register 28 and the clock input terminal of the register set 24 of the DC stage. Similarly, in the EX, MEM, WB stages after the above stage, there is a configuration that the nop signals S46, S46, S48 sent from the previous stage are inputted to the clock control circuits 43, 44, 45, and the above output signals S43, S44, S45 of the above clock control circuits 43, 44, 45 are inputted to the pipeline register 29, 30, 31 of the next stages and the data memory 26.

### Operation of the First Embodiment

The whole operation of the MPU of FIG. 1 is explained as follows. First, in the case where the nop is detected by the nop detecting circuit 41 from the instruction data S22 read from the instruction memory 22, the nop signal 541 from the above nop detecting circuit 41 becomes the enable signal (logic level “H” in the case hereof). The clock control circuit 42 halt outputting gated clock S42 during a period when the nop signal S41 has logic level “H”. Meanwhile, the nop signal S41 is inputted the F/F 46 placed between the FE/DC stages, and is sent to the next stage of DC stage to conduct the same operations.

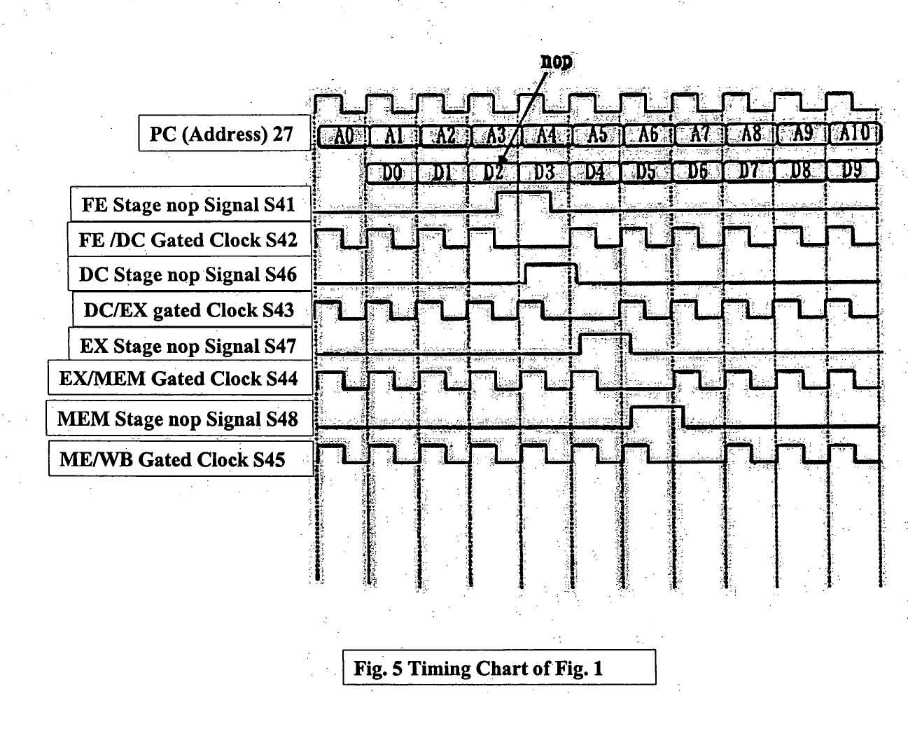

FIG. 5 is a view of timing chart showing an specific operation example of the MPU of FIG. 1. The timing chart thereof shows the timing of the nop outputted at the address number 2 (A2) and other states than the nop at other addresses.

When the address number 2 (A2) generated by the PC27 is provided the instruction memory 22, the instruction data S22 (D2) corresponding to the nop instruction is outputted at the rising edge of the next clock CK from the instruction memory 22, and the nop signal S41 is outputted from the nop detecting circuit 41. Subsequently, the gated clocks S42-S45 are outputted from the clock control circuits 42-45 of each of the FE, DC, MEM, WB stages, respectively, and the above gated clocks are sent to the pipeline registers 28-31, the register set 24, and the data memory 26. The timing of generating the above nop signal S41 and the signals flow of each of the nop signals S46-S48 of the FE, DC, MEM, WB stages and the gated clocks S42-S45 are shown in FIG. 5.

Providing the next-stage pipeline registers 28-31, etc. with the gated clocks S42-S45 can be halted corresponding to sending the nop to each of the FE, DC, EX, MEM, WB stages, by the circuit configuration of the MPU according to the first embodiment having the above mentioned signal flows.

### Effect of the First Embodiment

According to the first embodiment, the power consumption of the pipeline registers 28-31, the register set 24, and the data memory 26 being unnecessary to operate during the nop operation can be reduced by halting the gated clocks S24-S45 of the pipeline registers 28-31, etc. being unnecessary to operate, corresponding to sending of the nop. Furthermore, by halting the gated clocks S24-S45 of the pipeline registers 28-31, the input data of each of the FE, DC, EX, MEM, WB stages can be held and the operations of the combinational circuits of each of the FE, DC, EX, MEM, WB stages can be halted, therefore, further more reduction of the power consumption can be expected.

### Second Embodiment

### Configuration of the Second Embodiment

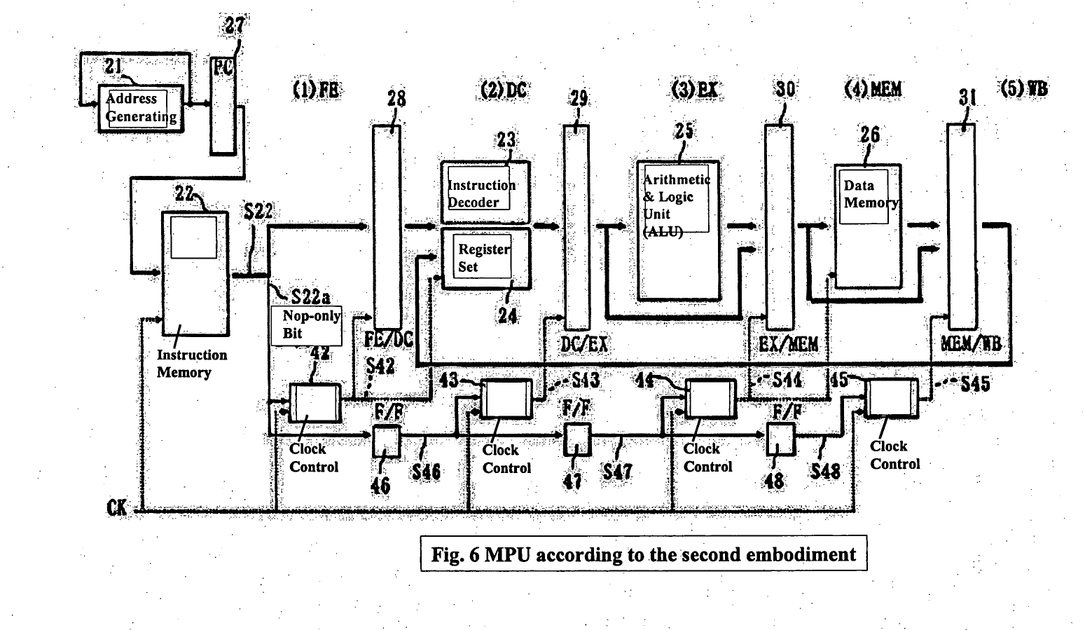

FIG. 6 is a view of general configuration diagram showing a configuration example of the RISC-type MPU according the second embodiment of the invention, and elements identical to ones in FIG. 1 of the first embodiment are given the same numerals as in FIG. 1.

The MPU according to the second embodiment is configured to include a nop-only bit S22a indicating logic level “H” in the case of the nop instruction, in the instruction data S22 outputted from the instruction memory 22 instead of the nop detecting circuit 41 according to the first embodiment, and is configured to input the above nop-only bit S22a directly to the clock control circuits 42 and the F/F 46 between the FE/DC stages. Other configurations are the same as in the first embodiment.

### Operation of the Second Embodiment

In the case where the instruction data 522 fetched from the instruction memory 22 is the nop, the nop-only bit S22a is set to logic level “H” . Therefore, in the FE stage, the gated clock S42 of the FE/DC pipeline register 28 and the register set 24 can be halted by inputting directly the one-bit nop-only bit S22a to the clock control circuit 42. At the same time, the same gated-clock control can be done in the subsequent EX, MEM, WB stages by inputting the nop-only bit S22a to the F/F 46 between the FE/DC stages.

### Effect of the Second Embodiment

In the case where the clock frequency is high, there is some possibility that the delay time in the path from the instruction memory 22 of the first embodiment to the nop detecting circuit 41, the clock control circuit 42 or the F/F 46 between the FE/DC stages becomes a problem.

In the above mentioned case, the delay time can be eliminated by including a nop-only bit S22a in the instruction data S22 as in the second embodiment and by using directly the above nop-only bit S22a as a clock control signal, and therefore a higher frequency operation becomes possible. Furthermore, the power consumption consumed in the nop detecting circuit 41 as in the first embodiment can be reduced.

### Third Embodiment

### Configuration of the Third Embodiment

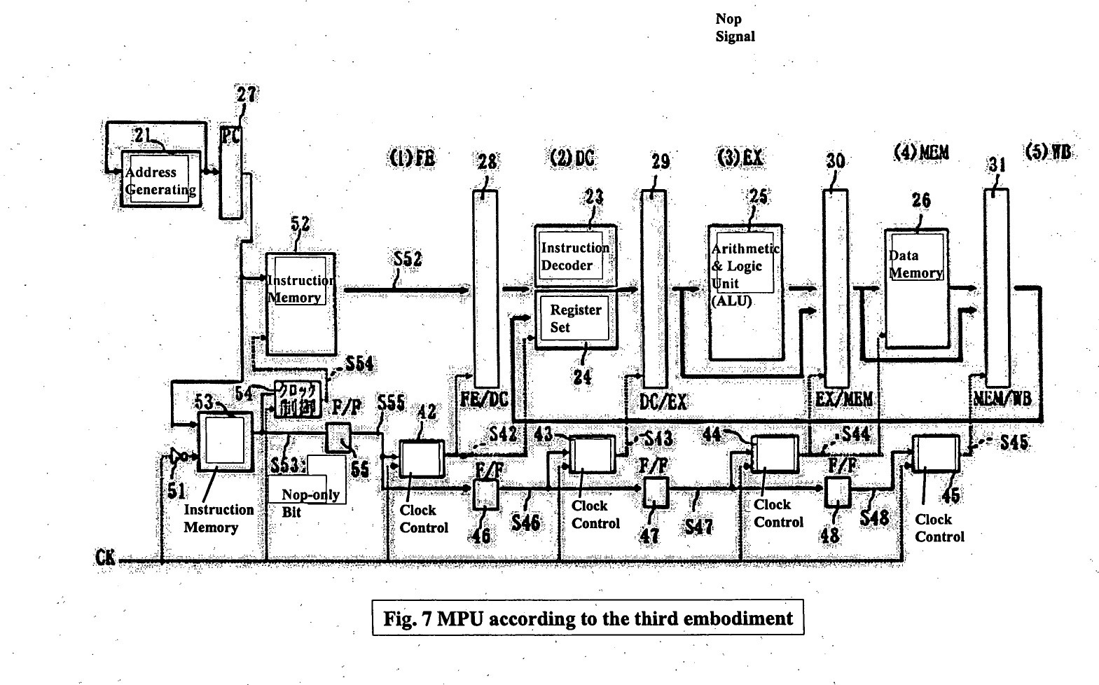

FIG. 7 is a view of general configuration diagram showing a configuration example of the RISC-type MPU according to the third embodiment, and elements identical to ones in FIG. 6 of the second embodiment are given the same numerals.

The MPU according to the third embodiment includes;

an inverter 51 for inverting the clock CK;

an instruction memory 52 for outputting an instruction data S52 assigned by the address from the PC27 based on a gated clock S54;

an instruction memory 53 for outputting a nop-only bit S53 assigned by the address from the PC 27 based on the inverted clock;

a clock control circuit 54 for outputting a gated clock S54 based on the clock CK and the nop-only bit S53; and

a F/F 55 for inputting the nop-only bit S53 and outputting a nop signal S55 to the clock control circuit 42 and the F/F 46.

Other configurations thereof are the same as in the second embodiment.

In other words, the MPU according to the third embodiment includes two instruction memories 52, 53, in addition to the configuration of the MPU according to the second embodiment. The instruction memory 52, one of the above instruction memories, stores the instruction data S52 other than the nop-only bit. The instruction memory 53, the other of the above instruction memories, stores only the nop-only bit S53, and is a one-bit memory. The above instruction memories 52, 53 are provided the same program addresses at the same timing by the PC 27. As described before, the output of the instruction memory 53 represents the nop-only bit S53, however, the output of the instruction memory 53 is inputted to the clock control circuit 54 and the clock CK is halted corresponding to the state thereof. The gated clock S54 of the output from the clock control circuit 54 is used as a clock of the instruction the memory 52. Meanwhile, the one-bit of nop-only bit S53 from the instruction memory 53 is provided the F/F 55 placed in the FE stage, and then the output from the F/F 55 of the one-cycle delayed signal is inputted to the clock control circuit 42, and the F/F 46 between the FE/DC stages, as the nop signal S55.

### Operation of the Third Embodiment

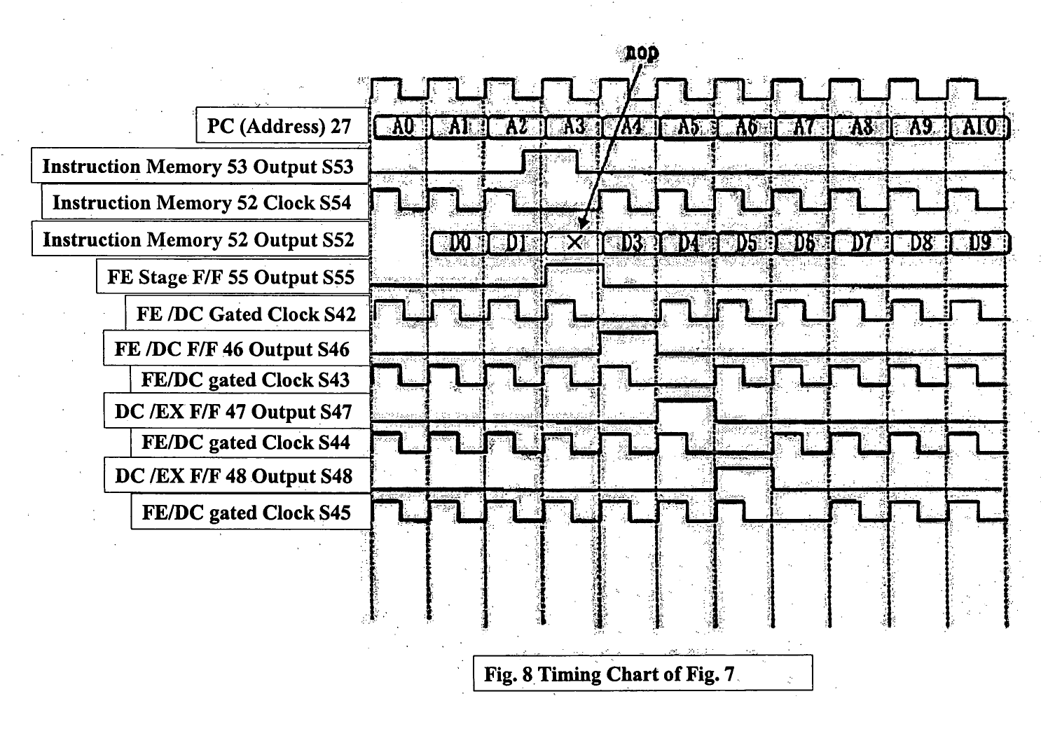

FIG. 8 is a view of timing chart showing the operation of the MPU of FIG. 7.

It is assumed that the address number 2 of the PC27 represents the nop instruction. The same address outputted from the PC 27 is inputted the instruction memory 52 and the instruction memory 53, however, since the clock CK is inverted by the inverter 51 and provided the instruction memory 53 storing the nop-only bit S53, the instruction memory 53 outputs the nop-only bit 553 at the falling edge of the clock during when the address number 2 A2 is being inputted.

Since the nop-only bit 553 from the instruction memory 53 is inputted to the clock control circuit 54 controlling the clock of the instruction memory 52, in the case where the instruction data S52 outputs logic level “H” indicating the nop, the clock control circuit 54 halts the next cycle of the gated clock S54. In the case where the instruction data S52 outputs logic level “L” not indicating the nop, the gated clock S54 is inputted. The above operation means that the nop-only bit S53 is only outputted a half cycle ahead, and in the case where the nop-only bit S53 indicates the nop, the next cycle of the gated clock S52 is halted, that is, during the nop operation, the instruction data S52 except the nop-only bit S53 is not fetched.

Meanwhile, the nop-only bit 553 from the instruction memory 53 is inputted to the F/F 55 placed in the FE stage, and is simultaneously delayed by one cycle of the clock to be provided the F/F 46 between the FE/DC stages. The output from the above F/F 46 is further delayed by one cycle of the clock and is used as the nop signal S46 of the DC stage. The following operations are the same as in the second embodiment of the invention.

### Effect of the Third Embodiment

According to the third embodiment, by including the instruction memory 53 for storing the nop-only bit S53, reading out the above nop-only bit S53 at a half cycle of the clock ahead and halting the fetch of other instruction data S52 becoming unnecessary when the instruction data S52 being read out at a half cycle of the clock ahead indicates the nop, the power consumption consumed by the instruction memory 52 during the nop can be reduced. At the same time, the same clock control operations become possible as in the first and the second embodiments, and then, a larger effect of reducing the power consumption can be expected.

### Fourth Embodiment

### Configuration of the Forth Embodiment

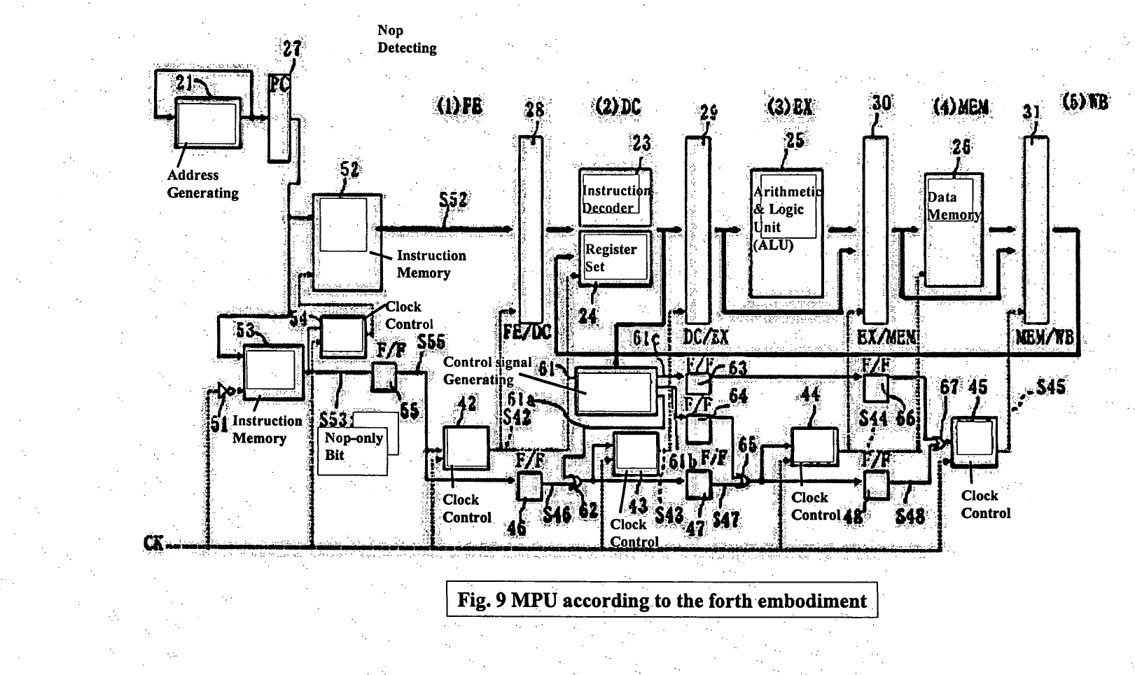

FIG. 9 is a view of general configuration diagram showing a configuration example of the RISC-type MPU according to the forth embodiment, and the identical elements therein to ones in FIG. 7 of the third embodiment are provided with the same numerals.

The forth embodiment of the invention includes a control signal generating circuit 61, disjunction gates (hereinafter referred to as ‘OR gate’) 62, 65, 67 and F/Fs 63, 64, 66, in addition to the configuration of the third embodiment, and other configuration is the same as in the third embodiment.

In other words, according to the forth embodiment of the invention, the control signal generating circuit 61 is included in the DC stage, in addition to the configuration of the third embodiment, and then, a plural of clock enable signals S61a, S61b, S61c for controlling clocks after each of the stages are outputted from the results of the instruction decoder 23. The S61a is the clock enable signal for controlling after the DC stage, the S61b is the signal for after the EX stage, and the S61c is the signal for after the MEM stage, respectively.

The clock enable signal S61a for controlling the clock after the DC stage is logically added to the nop signal S46 sent from the F/F 46 of the FE stage by the OR gate 62, and the logical operation result thereof is provided the clock control circuit 43 and is additionally sent by the F/F 47 as the nop signal S47 of after the EX stage. The clock enable signal S61b for controlling the clock after the EX stage is inputted to the F/F 64 placed between the DC/EX stages and the output from thereof is logically added to the nop signal sent S47 in the EX stage by the OR gate 65 in the EX stage as in the DC stage, and the logical operation thereof is provided the clock control circuit 44 and is additionally sent to the MEM stage. The clock enable signal S61c for controlling the clock after the MEM stage is sent to the F/F 63 placed between the DC/EX stages and to the F/F 66 placed between the EX/MEM stages, and the same operation as in the above mentioned case is done by the configuration thereof.

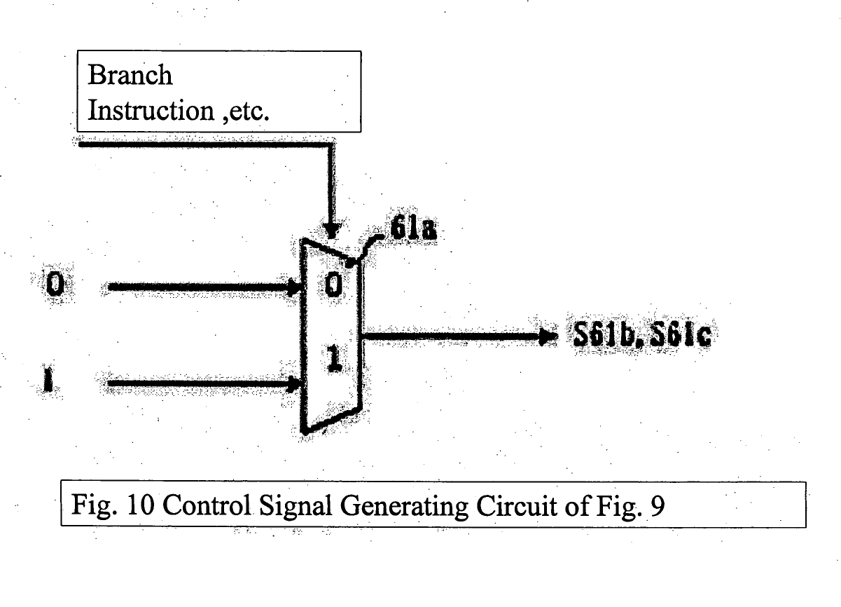

FIG. 10 is a view of configuration diagram showing an configuration example of the control signal generating circuit 61 of FIG. 9. The above control signal generating circuit 61 detects, for example, an instruction finishing the operation in the middle of the pipelines (for example, branch instruction, etc.) by the decoding results of the instruction decoder 23, and switches the selector 61a so at to output the clock enable signal S61b or the clock enable signal S61c of logic level “H” the decoding results, based on the decoding results thereof.

### Operation of the Forth Embodiment

In the case where a branch instruction operating in the DC stage is detected by the instruction decoder 23, for example, since the branch instruction is done in the DC stage and is passing through the subsequent EX, MEM, WB stages without operations, no problem arises even when the instruction thereof is recognized the nop. Therefore, the control signal generating circuit 61 sets the clock enable signal S61a to logic level “H” in order to recognize the branch instruction as the nop in the pipeline stages after the EX stage.

Meanwhile, the clock enable signal S61a and the nop signal S46 sent from the F/F 46 of the FE stage has logic level “L” due to the branch instruction, however, the above both signals is logically added to the clock enable signal S61a generated in the DC stage by the OR, gate 62, and then the logic operation result thereof inputted to the clock control circuit 43 becomes logic level “H”. Consequently, the clock provided the pipeline register 29 between the DC/EX stages is halted and at the same time, the output signal of the logical adding result thereof is sent to the EX stage by the F/F 47 as the nop signal of next EX stage.

### Effect of the Forth Embodiment

According to the forth embodiment, in the case where the operation is finished in the middle of the pipeline based on the detected instruction by the instruction decoder 23 in the DC stage (for example, in the cases of branch instruction, store instruction, and comparison instruction, etc. having no writing operation to the register set 24 at the end of the instruction cycle), by changing the subsequent operations to equivalent instructions of the nop by the control signal generating circuit 61, etc. (that is, gating the pipeline registers 29, 30, 31 as in the nop of first embodiment), the application cam be expanded to a lot of instructions other than the nop (for example, branch instruction, store instruction, and comparison instruction, etc. finishing the operations in the middle of the pipeline), and then a higher effect of the low power consumption can be expected.

### Fifth Embodiment

### Configuration of the Fifth Embodiment

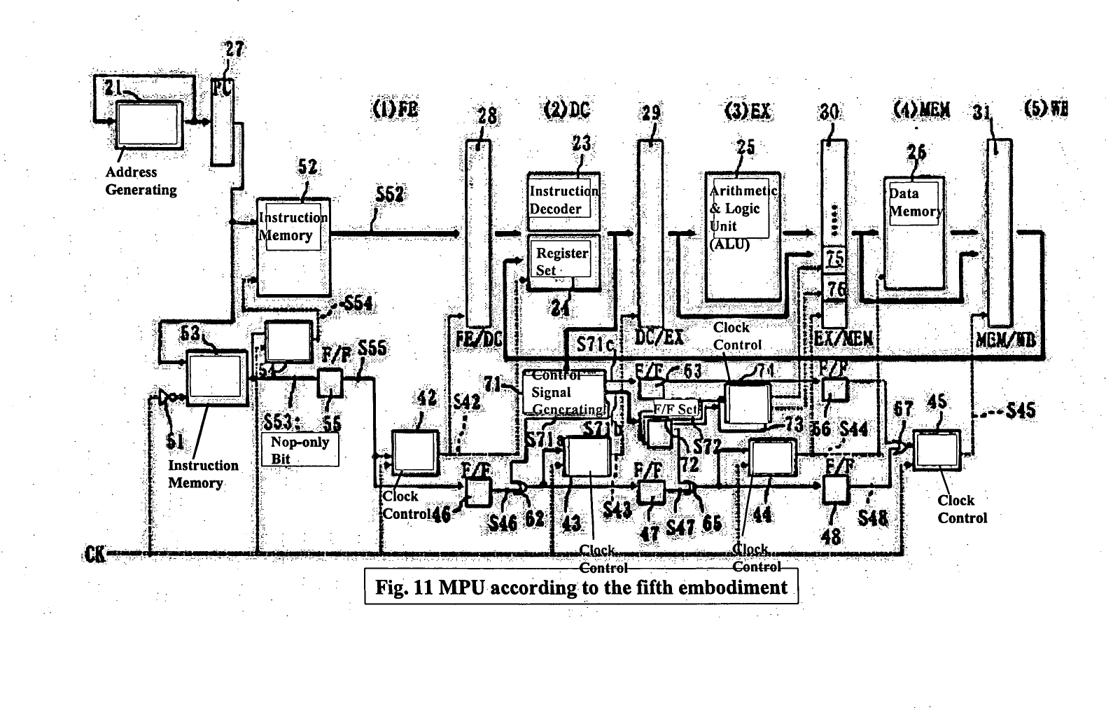

FIG. 11 is a view of general configuration diagram showing a configuration example of the RISC-type MPU according to the fifth embodiment, and the identical elements therein to ones in FIG. 9 of the forth embodiment are provided with the same numerals.

The fifth embodiment of the invention includes a control signal generating circuit 71, a F/F set 72, clock control generating circuits 73, 74 and EX/MEM pipeline registers 75, 76, instead of the control signal generating circuit 61 and the F/F 64.

In other words, according to the fifth embodiment, in addition to the configuration of the forth embodiment, a plural of the clock halting control signals (for example, clock enable signals) S71b besides the clock enable signals S71a, S71c are outputted from the control signal generating circuit 71 for generating the clock enable signal, and are provided the F/F set 72 placed between the DC/EX. The clock control circuits 73, 74 provide the EX/MEM pipeline registers 75, 76 with the clock. The subsequent configurations are the same as in the forth embodiment.

The reason why the F/F set 72, a plural of the clock control circuits 73, 74, and the EX/MEM pipeline registers 75, 76 needs to be included, respectively, are as follows. In the pipeline register 30 and the MEM/WB pipeline register 31, a plural of registers exist, respectively, and then whether the registers thereof are activated or not, is determined by the instruction. Consequently, the registers to be clock-controlled are selected by the instruction, and therefore, the clock control circuits 73, 74 become necessary with respect of each of the above registers.

### Operation of the Fifth Embodiment

The characteristic operation of the fifth embodiment will be explained as below. The control signal generating circuit 71 outputs the clock enable signal S71b of the control signal for halting the EX pipeline registers 75, 76, based on the instruction detected by the instruction decoder 23. The F/F set 72 receives the above clock enable signal S71b and delay the clock enable signal thereof by one clock cycle to adjust the timing thereof with the operating instruction. If the above enable signal is not delayed, the current instruction detected in the DC stage conducts gating the EX/MEM pipeline register 30 being used by the one-cycle-ahead instruction. The purpose of the aforementioned delaying the clock enable signal by one clock cycle is to avoid the above malfunction.

The clock control circuits 73, 74 receive the signal from the register set 72 and halt the clock to the EX/MEM pipeline registers 75, 76.

### Effect of the Fifth Embodiment

According to the fifth embodiment, when the instruction is not the nop, the clock of non active registers in the pipeline registers 28-31 (for example, the EX/MEM pipeline register 75, 76) is halted so as not to change the data.

For example, three of the address, WBV, BPR pipeline registers are assumed to be in the EX/MEM stages. The pipeline register address is the output to the data memory 26. Consequently, in the case of the operating instruction, the pipeline register address is not activated. Therefore, in the case of the operating instruction, by halting the clock of the pipeline register address and not changing the data, the output of the pipeline register is configured not to toggle.

By the aforementioned configuration, the power consumption of each of the pipeline registers 28-31 can be reduced, and then the reducing effect of the power consumption can be achieved in the larger part thereof.

### Modification:

The present invention is not limited to from the first to the fifth embodiment, and various applications and modifications are possible. The following (a)-(b) are examples of the above applications and the modifications.

(a) The embodiments show examples of the case of five-stage pipeline, however, the present invention is applicable independently from numbers of the pipeline stages.

(b) The present invention can be broadly applied to all circuits, for example, digital signal processors, etc. having pipeline systems.

(c) According to the embodiments, logic level “H” is used as the control signal indicating the nop, however, the control signal is not limited to the above level.

(d) According to the third embodiment, a power consumption reducing method by controlling the gated clock S54 being inputted to the clock input terminal of the instruction memory 52 is shown, however, for example, in the case where the instruction memory 52 includes enable signal input terminal, etc., by inputting the gated clock S54 to the above enable signal input terminal, etc., the nop becomes unnecessary to be fetched, and therefore, reducing power consumption becomes possible.

What is claimed is:

1. A microprocessor characterized by comprising;
a non-operation detecting circuit being configured to detect a non-operation from instruction data fetched from an instruction memory and output a non-operation signal;
a plural of flip-flops being configured to be placed between each of a plural of pipelines and send said non-operation signal to said each of a plural of pipelines;
a plural of clock control circuits being configured to be placed in said each of pipelines, halt the clock for activating a stage of said each of pipelines' in said stage of said each of pipelines based on said non-operation signal during when said non-operation signal being sent to said each of pipelines, and simultaneously hold the input data in said stage of said each of pipelines.

2. A microprocessor characterized by comprising;
a instruction memory being configured to store instruction data including a non-operation-only bit indicating whether the instruction is non-operation, or not;
a plural of flip-flops being configured to be placed between each of a plural of pipelines and send said non-operation signal of said non-operation-only bit to said each of a plural of pipelines in the case where said non-operation-only bit of said instruction data being read from said instruction memory indicates non-operation;
a plural of clock control circuits being configured to be placed in said each of pipelines, halt the clock for activating a stage of said each of pipelines in said, stage of said each of pipelines based on said non-operation signal during when said non-operation signal being sent to said each of pipelines, and simultaneously hold the input data in said stage of said each of pipelines.

3. A microprocessor characterized by comprising;
a first instruction memory being configured to have instruction data except a non-operation-only bit in the case where a instruction is a non-operation and operate at the leading edge of a clock;
a second instruction memory being configured to store only said non-operation-only bit and operate at the trailing edged of the clock a half cycle ahead from said clock;
a first clock control circuit being configured to halt the clock of said first instruction memory when said non-operation-only bit is read from said second instruction memory;
a first flip-flop being configured to be placed in the first stage of fetch stage of a plural of pipelines and adjust the timing of said non-operation-only bit read from said second instruction memory to output a non-operation signal;
a plural of second flip-flops being configured to be placed between each of said plural of pipelines and send said non-operation signal to each of said plural of pipelines;
a plural of second clock control circuits being configured to be placed each of said plural of pipelines, halt the clock for activating each of said plural of pipelines based on said non-operation signal during when said non-operation signal being be sent to each of said plural of pipelines, and hold simultaneously an input data into said each of said plural of pipelines.

4. A microprocessor characterized by comprising;
a control signal generating circuit being configured to be placed in a decode stage of a plural of pipelines and generate a plural of clock enable signals based on decoding results of an instruction decoder;
a plural of flip-flops being configured to be placed between said each of pipelines in an execution stage and a memory stage after said decode stage and send said plural of clock enable signals to said execution stage and said memory stage;
a plural of non-operation signal generating circuits being configured to placed in said execution stage and said memory stage, respectively, and generate a non-operation signal based on said plural of clock enable signals;
a plural of clock control circuits being configured to be placed in said execution stage and said memory stage, respectively, and halt each of clocks for activating said execution stage and said memory stage based on said non-operation signal when said decoding result indicates that an instruction finishes the operation in the middle of pipeline stages.

5. A microprocessor characterized by comprising;
a control signal generating circuit being configured to be placed in a decode stage of a plural of pipelines and generate a plural of clock-halting control signals based on decoding results of an instruction decoder;
a plural of flip-flops being configured to be laced between said plural of pipelines after said decode stage and send said plural of clock halt control signals;
a plural of clock control circuits being configured to be placed in stages of said plural of pipelines after said decode stage and halt clocks for activating partially said stags of said plural of pipelines after said decode stage based on said clock halt control signal.
